(19) United States
(12) Patent Application Publication
(10) Pub. No.: US 2018/0093228 A1
(43) Pub. Date: Apr. 5, 2018

(54) METHOD FOR PREPARING ANTHRAQUINONE-FUNCTIONALIZED POLY(VINYLIDENE FLUORIDE) MEMBRANE

(71) Applicant: XIAMEN UNIVERSITY OF TECHNOLOGY, Xiamen (CN)

(72) Inventors: Bin YAN, Xiamen (CN); Yuping WANG, Xiamen (CN); Qian YE, Xiamen (CN)

(73) Assignee: XIAMEN UNIVERSITY OF TECHNOLOGY, Xiamen (CN)

(21) Appl. No.: 15/821,845

(22) Filed: Nov. 24, 2017

Related U.S. Application Data
(63) Continuation of application No. PCT/CN2016/103560, filed on Oct. 27, 2016.

(30) Foreign Application Priority Data
Jan. 13, 2016 (CN) 2016100199071

(51) Int. Cl. B01D 69/12; B01D 71/34; B01D 61/14; B01D 67/00; C02F 1/44; C08F 8/00; C08J 7/12

(52) U.S. Cl. CPC B01D 69/125; B01D 71/34; B01D 61/145; B01D 67/0006; C08J 2327/16; C08F 8/00; C08J 7/12; B01D 2323/40; B01D 2323/36; C02F 1/444

(57) ABSTRACT

This present disclosure relates to a method for preparation of polyvinylidene fluoride membrane with functional anthraquinones. The method is carried out according, to the following steps: step 1: preparing 2-(1-hydroxy-3-butene)-1,4,5,8-tetramethoxyl naphthalene; step 2: preparing polyvinylidene fluoride-aromatic ether copolymers: polyvinylidene fluoride was used as the initiator, 2-(1-hydroxy-3-butene) -1,4,5,8-tetramethoxynaphthalene was the monomer, N,N-dimethylformamide was solvent, cuprous chloride/Me6TREN was the catalytic, polyvinylidene fluoride-aromatic ether copolymer was synthesized by atomic transfer radical polymerization; step 3: reducing the polyvinylidene fluoride-aromatic ether copolymer to quinone by demethoxy oxidation; step 4: using the product of step 3 and N, N-dimethylformamide a film-forming reagents, then scraping into a membrane. Further, the anthraquinone which fixed in the polyvinylidene fluoride membrane would not fall off.

### CROSS-REFERENCE TO RELATED APPLICATIONS

The present application is a U.S. continuation application based on International Application No. PCT/CN2016/103560 filed on 27 Oct. 2016, which claims priority from Chinese patent Application No. 2016100199071, filed on Jan. 13, 2016, the entire contents of which are incorporated herein by reference.

### TECHNICAL FIELD

The present invention relates to a method for preparation of polyvinylidene fluoride membrane with functional anthraquinones.

### BACKGROUND OF THE INVENTION

Polyvinylidene fluoride (PVDF), because of its high mechanical strength, good chemical stability, good halogen resisting, excellent resistance to acid, alkali, oxidizing agents and anti-UV properties, has been widely used as raw materials for preparing the membrane material in the Environmental engineering. However, the disadvantages of high surface hydrophobicity and low surface energy of polyvinylidene fluoride would influence the service life of the membrane material. In order to further optimize the performance of polyvinylidene fluoride membrane, the researchers conducted a series of studies. CN 101879418A discloses a method for preparing a polyvinylidene fluoride membrane modified by blending reaction, which specifically refers to preparing a polyvinylidene fluoride membrane by adding porogen and polyacrylonitrile in the film-forming reagents. CN 102140181A discloses a method for the grafting of functional polymer on the surface of polyvinylidene fluoride membrane, which is accomplished via atom transfer radical polymerization of aqueous phase. This method enables the functionalization of the polyvinylidene fluoride membrane, and the resulting membrane has good hydrophilicity and antifouling ability. CN 104480636A describes the preparation of PVDF/MMT composite fiber membranes by electrospinning. This invention was indicated that the membrane could be widely used for the treatment of oil spill and oily wastewater with its excellent hydrophobicity and oil absorbency by introducing the modified MMT into the polymer. The above researches have instructive significance to optimize the membrane performance and prolong the service life of the membrane, but their application principle is still based on physical separation, that is, the transfer and enrichment of pollutants, does not realize the degradation of pollutants, there is still possible harm to the environment. Therefore, it is of great significance to study and develop a membrane that can purify sewage and degrade pollutants.

The high concentration of nitrogen-containing domestic sewage, industrial wastewater and farmland surface water runoff into the lake, reservoir, river and bay waters, then cause some of the algae in the water to reproduce, and seriously deteriorate water quality, damage the ecological balance of water. Biological method is the most common method to solve the above-mentioned problem of water pollution, but it is limited by the electron transport rate in the process of biological denitrification, the effect of biological treatment is unstable and the treatment efficiency is low. It has been found that the redox mediator can accelerate the electron transport rate in the process of biological denitrification and improve the efficiency of biological treatment. Anthraquinone was one kind of redox mediators, there were many researches which have confirmed that anthraquinone compounds can effectively promote the degradation of nitrogenous waste water. There were many reports that anthraquinones were put into use directly, which would cause the loss of anthraquinones and bring about the secondary pollution. In order to solve the above problems, the researchers carried out a series of studies to avoid the loss of anthraquinones. Zhiyuan M A et al (Enhanced bio-decolorrization of acid red B with immobilized redox mediator[J]. Hei bei journal of Industrial Science and Technology. 2013(5), Vol. 30, No. 3) have found that 1,5-dichloroanthraquinone which was immobilized in calcium alginate could promote the decolorization of acid red B, but it was only bound by the physical three on the carrier, easy to fall off from the carrier Jing LIAN et al (Biological catalyzing denitrification of nitrite by immobilized redox mediator[J]. Chinese Journal of Environmental Engineering. 2012(6), Vol. 6, No. 6) discovered a method for the fixation of anthraquinone sulfonate by using cyclic voltammetry. The result showed that the immobilized anthraquinone sulfonate can accelerate the process of nitrite biodegradation. However, the method of cyclic voltammetry for fixing anthraquinone sulfonate was very complex as it was controlled by the preparation of polypyrrole membrane, which was affected by a variety of factors. Therefore, if the redox mediator is fixed on the membrane, it can effectively solve the problem of fixation of redox mediator and improve the efficiency of treatment of wastewater with high nitrogen concentration.

### BRIEF SUMMARY OF THE INVENTION

The invention provides methods for the chemical modification of polyvinylidene fluoride membrane with anthraquinones. Further, the invention indicates that the redox mediator is fixed on the polyvinylidene fluoride by the method of chemical synthesis and chemical modification, and solves the problem that the quinone which appears in the physical fixing method is easy to fall off from the carrier, and avoid the secondary pollution. Obviously, the modification of polyvinylidene fluoride with anthraquinones has good application prospects in the field of the treatment of nitrogen-containing wastewater.

More specifically, the synthesis procedure of the modification of polyvinylidene fluoride membrane with anthraquinones is carried out according to the following steps:

Step 1: preparing 2-(1-hydroxy-3-butene)-1,4,5,8-tetramethoxyl naphthalene:

Step 1a). preparing 1,4,5,8-tetramethoxynaphthalene:

Adding naphthazarin, tetramethylammonium bromide and tetrahydrofuran to a round bottom flask, stirring to dissolve, then adding sodium dithionite aqueous solution and dimethyl sulfate solution, stirring evenly; then moving the round bottom flask to ice water bath, reacting for 1 h, then slowly dropping NaOH aqueous solution into the flask. After the drop adding, removing the ice bath, continue to react at room temperature for 30 min, and stirring continuously for 18 h until the reaction was complete. Then extracting the reaction solution with ethyl acetate, washing with saturated brine, drying by anhydrous magnesium sulfate, filtering, and recovering of ethyl acetate under reduced pressure. Finally, separating the solids by column chromatography to obtain the 1,4,5,8-tetramethoxynaphthalene;

Step 1b). preparing 1,4,5,8-tetramethoxynaphthalene-2-carboxaldehyde:

Adding N,N-2-methylacetamide to the 2 mouth flask, removing the flask in an ice-water bath, slowly dropping phosphorus oxychloride and 0.063 mol/L 1,4,5,8-tetramethoxynaphthalene in chloroform solution. After the drop adding, removing the ice bath, heating and refluxing reaction for 5 h; then adding ice water to stop the reaction, extracting by chloroform, saturated brine washing, anhydrous magnesium sulfate drying, then filtering, and negative pressure recovery of chloroform, separating by column chromatography;

Step 1c). preparing 2-(1-hydroxy-3-butene)-1,4,5,8-tetramethoxynaphthalene:

Under the protection of argon, adding molecular sieve, anhydrous tetrahydrofuran anhydrous chromium trichloride and manganese powder in turn in the dry 2 mouth flask, stirring until the color becomes black, then adding allyl bromide, and adding 1,4,5,8-tetramethoxynaphthalene-2-carbaldehyde and trimethylchlorosilane, reacting for 3 h, adding sodium bicarbonate to stop the reaction, washing with diatomite and ether, extracting by ether, saturated brine washing, anhydrous magnesium sulfate drying, and negative pressure recovery of the concentrated residue, dissolving in tetrahydrofuran and hydrolyzing with 10% hydrochloric acid, stirring at room temperature for 10 min, extracting with ether, washing with saturated brine, anhydrous magnesium sulfate drying and concentrating under reduced pressure, then separating by column chromatography;

The mass ratio of naphthazarin, tetrahydrofuran, sodium dithionite, dimethyl sulfate and sodium hydroxide in step 1a) is 1.2-2:70-80:50-60:100-120:100-150.

The volume ratio of N,N-2-methylacetamide, phosphorus oxychloride, 1,4,5,8-tetramethoxynaphthalene in chloroform in step 1b) is 2-3:2-5:10-25.

The mass ratio of anhydrous tetrahydrofuran, anhydrous chromium trichloride, 1,4,5,8-tetramethoxynaphthalene-2-carbaldehyde, trimethylchlorosilane, allyl bromide, manganese powder in step 1c) is 10-30:10-30:30-60:30-80:30-80:600-800.

The eluants used in the step (1a), step (1b) and (1c) are the petroleum ether and acetone mixed solvent in volume ratio of 4:1.

Step 2: preparing polyvinylidene fluoride-aromatic ether copolymers:

Polyvinylidene fluoride was used as the initiator, 2-(1-hydroxy-3-butene) -1,4,5,8-tetramethoxynaphthalene was the monomer, N,N-dimethylformamide was solvent, cuprous chloride/Me6TREN was the catalytic, polyvinylidene fluoride-aromatic ether copolymer was synthesized by atomic transfer radical polymerization.

In step 2, adding polyvinylidene fluoride and N,N-dimethylformamide to double glass reactor (As shown in FIG. 3), stirring evenly, then adding Me₆TREN and 2-(1-hydroxy-3-butene) -1,4,5,8-tetramethoxynaphthalene, injecting argon to remove oxygen for 30 min, adding cuprous chloride, removing oxygen for 1 hour, then sealing the reactor, removing the reactor to ice-water bath, reacting for 20 s-3 min under the ultraviolet irradiation in the magnetic stirring, then filtering with ethanol and water of a volume ratio of 1:1 after the reaction, then extracting with chloroform several times, finally vacuum-drying to obtain the polyfluoroethylene-aromatic ether copolymer.

The mass ratio of 2-(1-hydroxy-3-butene)-1,4,5,8-tetramethoxynaphthalene, polyvinylidene fluoride, N,N-dimethylformamide, the catalytic in step 2 is 30-60:5-12:400-550:0.1-1.

More specifically, wherein the outer layer of the double glass reactor is provided with a water inlet and a water outlet, connected with the constant temperature circulating water bath to keep the temperature constant, the inner layer is provided with an air inlet, an vacuum orifice and an inlet port, and the reaction is carried out under a nitrogen atmosphere, the top is covered with quartz glass to reduce the UV radiation during the absorption of ultraviolet light, the wavelength of the UV lamp used is 365 nm and the power is 1000W.

Step 3: reducing the polyvinylidene fluoride-aromatic ether copolymer to quinone by demethoxy oxidation:

More specifically, adding the polyvinylidene fluoride-aromatic ether copolymer of acetonitrile solution in the 2 mouth flask, adding cerium ammonium nitrate aqueous solution at room temperature with stirring, reacting for 1 hour, negative pressure recovery of acetonitrile, extracting with chloroform, washing with water, and washing with saturated brine, anhydrous magnesium sulfate drying for 1.5 hour, negative pressure recovery of chloroform, separating the solids by column chromatography to obtain the mixture of 2-(1-hydroxy-3-butene) -5,8-dimethoxy-1,4-naphthoquinone and 5-(1-hydroxy-3-butene) -5,8-dimethoxy-1,4-naphthoquinone, finally vacuum drying.

The eluent of silica column chromatography is the mixture of the petroleum ether and acetone with a volume ratio of 3:1.

Step 4: using the product of step 3 and N,N-dimethylformamide as film-forming reagents, then scraping into a membrane.

The mass ratio of N,N-dimethylformamide and the product of step 3 is 15-20:80-85.

The above preparation process is divided into four steps:

(1) In the invention, the double bond of side chain was introduced into the naphthazarin by the NHK reaction. Further, this invention contributed to facilitate the occurrence of the atomic transfer radical polymerization (ATRP) reaction between the polymer material and the anthraquinone.

(2) The grafted PVDF-aromatic ether copolymer was synthesized by ATRP method to make the polyvinylidene fluoride functional.

(3) The quinone was prepared by demethylation to make the polyvinylidene fluoride anthraquinone functional.

(4) The polyvinylidene fluoride material which functionalized with anthraquinone was prepared by phase conversion method.

The present invention offers the following significant advantages:

(1) As pure anthraquinone compounds can not carry out the atomic radical polymerization, our invention introduced the double bond of side chain into the naphthazarin by the NHK reaction, and contributed to facilitate the occurrence of the atomic transfer radical polymerization (ATRP) reaction between the polymer material and the anthraquinone. Further, the anthraquinone which fixed in the polyvinylidene fluoride membrane would not fall off;

(2) The polyvinylidene fluoride membrane as fixed carrier for the redox mediator can be adapted to various membrane processing apparatuses and facilitates the promotion and application of the present invention.

(3) The invention can effectively promote the degradation of waste water with high concentration nitrogenous, and especially accelerate the degradation of printing and dyeing wastewater.

### BRIEF DESCRIPTION OF THE DRAWINGS

The drawings included herein are for the purpose of illustrating the exemplified embodiments and shall not limit the scope of the present invention. Other drawings may be produced by those skilled in the art without creative effort.

FIG. 1 is the schematic diagram of preparing of 2-(1-hydroxy-3-butene) -1,4,5,8-tetramethoxynaphthalene;

FIG. 2 is the schematic diagram of preparing of polyvinylidene fluoride-aromatic ether copolymer.

FIG. 3 is the sketch of double glass reactor: 1—the place of ultraviolet light, 2—vacuum orifice, 3—water inlet, 4—feed inlet, 5—water outlet, 6—inlert port.

FIG. 4 is the FTIR spectra of polyvinylidene fluoride membrane modified with anthraquinones.

FIG. 5 is the graph about the application effect of the polyvinylidene fluoride membrane modified with anthraquinones. The abscissa shows the times of circle application of the polyvinylidene fluoride membrane with functional anthraquinones, the ordinate shows the multiple of removal rate of nitrate. As can be seen from the graph, the ultrafiltration membrane of our invention has stable performance and can be recycled several times.

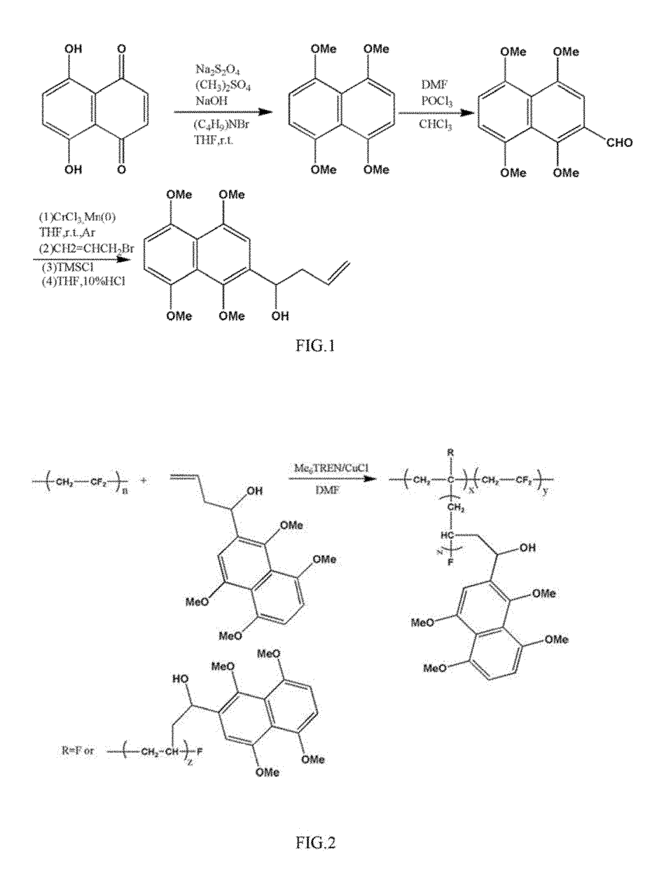

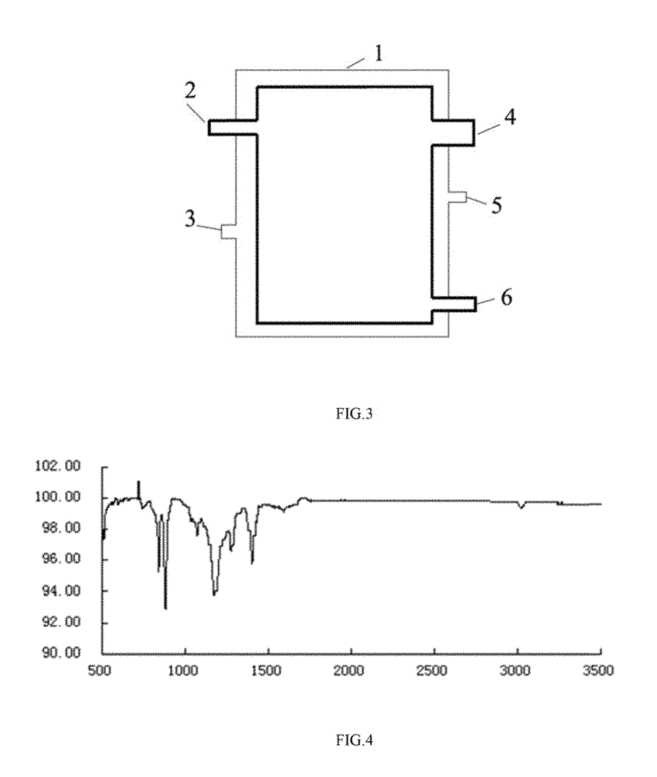

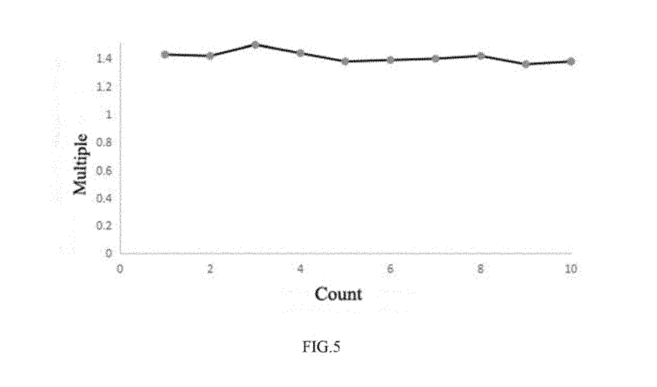

### DETAILED DESCRIPTION OF THE INVENTION

The present invention is further described in the following exemplified embodiments to illustrate the application of the principles of the invention. It is understood that the invention may be embodied otherwise without departing from such principles. The scope of the claims of the present invention expressly should not be limited to such exemplary or preferred embodiments.

### Embodiment 1

The method for preparation of polyvinylidene fluoride membrane with functional anthraquinones comprises the following steps:

Step 1: preparing 2-(1-hydroxy-3-butane)-1,4,5,8-tetramethoxyl naphthalene:

1a). preparing 1,4,5,8-tetramethoxynaphthalene:

Adding naphthazarin, tetramethylammonium bromide and tetrahydrofuran to a round bottom flask, stirring to dissolve, then adding sodium dithionite aqueous solution and dimethyl sulfate solution, stirring evenly; then moving the round bottom flask to ice water bath, reacting for 1 h, then slowly dropping NaOH aqueous solution into the flask. After the drop adding, removing the ice bath, continue to react at room temperature for 30 min, and stirring continuously for 18 h until the reaction was complete. Then extracting the reaction solution with ethyl acetate, washing with saturated brine, drying by anhydrous magnesium sulfate, filtering, and recovering of ethyl acetate under reduced pressure. Finally, separating the solids by column chromatography to obtain the 1,4,5,8-tetramethoxynaphthalene; 1 H NMR (400 MHz, DMSO); δ6.44 (d, 4 H), 3.37 (s, 12 H, CH₃).

The mass ratio of naphthazarin, tetrahydrofuran, sodium dithionite, dimethyl sulfate and sodium hydroxide is 1.5:75:55:110:125;

1b). preparing 1,4,5,8-tetramethoxynaphthalene-2-carboxaldehyde:

Adding N,N-2-methylacetamide to the 2 mouth flask, removing the flask in an ice-water bath, slowly dropping phosphorus oxychloride and 0.063 mol/L 1,4,5,8-tetramethoxynaphthalene in chloroform solution, After the drop adding, removing the ice bath, heating and refluxing reaction for 5 h; then adding ice water to stop the reaction, extracting by chloroform, saturated brine washing, anhydrous magnesium sulfate drying, then filtering, and negative pressure recovery of chloroform, separating by column chromatography; 1 H NMR (400 MHz, DMSO): δ6.49-6.51 (m, 3 H), 3.40 (s, 9 H, CH₃), 3.43 (s, 3 H, CH₃), 10.11 (s, 1H, CHO).

The volume ratio of N,N-2-methylacetamide, phosphorus oxychloride, 1,4,5,8-tetramethoxynaphthalene in chloroform is 2.5:3:15.

1c). preparing 2-(1-hydroxy-3-butene)-1,4,5,8-tetramethoxynaphthalene:

Under the protection of argon, adding molecular sieve, anhydrous tetrahydrofuran, anhydrous chromium trichloride and manganese powder in turn in the dry 2 mouth flask, stirring until the color becomes black, then adding allyl bromide, adding 1,4,5,8-tetramethoxynaphthalene-2-carbaldehyde and trimethylchlorosilane, reacting for 3 h, adding sodium bicarbonate to stop the reaction, washing with diatomite and ether, extracting by ether, saturated brine washing, anhydrous magnesium sulfate drying, and negative pressure recovery of the concentrated residue, dissolving in tetrahydrofuran, and hydrolyzing with 10% hydrochloric acid, stirring at room temperature for 10 min, extracting with ether, washing with saturated brine, anhydrous magnesium sulfate drying and concentrating under reduced pressure, then separating by column chromatography; 1 H NMR (400 MHz, DMSO): δ6.47-6.51 (m, 3H), 3.37 (s, 9 H, CH₃), 3.43 (s, 3 H, CH₃), 8.45 (s, 1H, OH), 4.83 (t, 1H, CH), 2.39 (m, 2H, CH₂), 4.92 (d, 2H, CH₂) 5.76 (m, 1H, CH).

The mass ratio of anhydrous tetrahydrofuran, anhydrous chromium trichloride, 1,4,5,8-tetramethoxynaphthalene-2-carbaldehyde, trimethylchlorosilane, allyl bromide, manganese powder is 20:20:50:60:50:700.

Step 2: preparing polyvinylidene fluoride-aromatic ether copolymers:

adding polyvinylidene fluoride and N,N-dimethylformamide to double glass reactor, stirring evenly, then adding Me₆TREN and 2-(1-hydroxy-3-butene) -1,4,5,8-tetramethoxynaphthalene, injecting argon to remove oxygen for 30 min, adding cuprous chloride, removing oxygen for 1 hour, then sealing the reactor, removing the reactor to ice-water bath, reacting for 20 s-3 min under the ultraviolet irradiation in the magnetic stirring, filtering with the volume ratio of 1:1 of ethanol and water after the reaction, then extracting with chloroform several times, finally vacuum-drying to obtain the polyfluoroethylene-aromatic ether copolymer.

The mass ratio of 2-(1-hydroxy-3-butene)-1,4,5,8-tetramethoxynaphthalene, polyvinylidene fluoride, N,N-dimethylformamide, cuprous chloride/Me6TREN is 45:7:500:0.5.

Step 3: reducing the polyvinylidene fluoride-aromatic ether copolymer to quinone by demethoxy oxidation:

More specifically, adding the polyvinylidene fluoride-aromatic ether copolymer of acetonitrile solution in the 2 mouth flask, adding cerium ammonium nitrate aqueous solution at room temperature with stirring, reacting for 1 hour, negative pressure recovery of acetonitrile, extracting with chloroform, washing with water, and washing with saturated brine, anhydrous magnesium sulfate drying for 1.5 hour, negative pressure recovery of chloroform, separating the solids by column chromatography to obtain the mixture of 2-(1-hydroxy-3-butene) -5,8-dimethoxy-1,4-naphthoquinone and 6-(1-hydroxy-3-butene) -5,8-dimethoxy-1,4-naphthoquinone, finally vacuum drying.

The eluent of silica column chromatography is the mixture of the petroleum ether and acetone with a volume ratio of 3:1.

Step 4: using the product of step 3 and N,N-dimethylformamide as film-forming reagents, then scraping into a membrane.

The mass ratio of N,N-dimethylformamide and the product of step 3 is 17:82.

### Embodiment 2

The method for preparation of polyvinylidene fluoride membrane with functional anthraquinones comprises the following steps:

Step 1: preparing 2-(1-hydroxy-3-butene)-1,4,5,8-tetramethoxyl naphthalene:

1a). preparing 1,4,5,8-tetramethoxynaphthalene:

Adding naphthazarin, tetramethylammonium bromide and tetrahydrofuran to a round bottom flask, stirring to dissolve, then adding sodium dithionite aqueous solution and dimethyl sulfate solution, stirring evenly; then moving the round bottom flask to ice water bath, reacting for 1 h, then slowly dropping NaOH aqueous solution into the flask. After the drop adding, removing the ice bath, continue to react at room temperature for 30 min, and stirring continuously for 18 h until the reaction was complete. Then extracting the reaction solution with ethyl acetate, washing with saturated brine, diving by anhydrous magnesium sulfate, filtering, and recovering of ethyl acetate under reduced pressure. Finally, separating the solids by column chromatography to obtain the 1,4,5,8-tetramethoxynaphthalene;

The mass ratio of naphthazarin, tetrahydrofuran, sodium dithionite, dimethyl sulfate and sodium hydroxide is 1.2:80:50:120:150;

1b). preparing 1,4,5,8-tetramethoxynaphthalene-2-carboxaldehyde:

Adding N,N-2-methylacetamide to the 2 mouth flask, removing the flask in an ice-water bath, slowly dropping phosphorus oxychloride and 0.063 mol/L 1,4,5,8-tetramethoxynaphthalene in chloroform solution. After the drop adding, removing the ice bath, heating and refluxing reaction for 5 h; then adding ice water to stop the reaction, extracting by chloroform, saturated brine washing, anhydrous magnesium sulfate drying, then filtering, and negative pressure recovery of chloroform, separating by column chromatography;

The volume ratio of N,N-2-methylacetamide, phosphorus oxychloride, 1,4,5,8-tetramethoxynaphthalene in chloroform is 2:5:10.

1c) preparing 2-(1-hydroxy-3-butene)-1,4,5,8-tetramethoxynaphthalene:

Under the protection of argon, adding molecular sieve, anhydrous tetrahydrofuran, anhydrous chromium trichloride and manganese powder in turn in the dry 2 mouth flask, stirring until the color becomes black, then adding allyl bromide, adding 1,4,5,8-tetramethoxynaphthalene-2-carbaldehyde and trimethylchlorosilane, reacting for 3 h, adding sodium bicarbonate to stop the reaction, washing with diatomite and ether, extracting by ether, saturated brine washing, anhydrous magnesium sulfate drying, and negative pressure recovery of the concentrated residue, dissolving in tetrahydrofuran, and hydrolyzing with 10% hydrochloric acid, stirring at room temperature for 10 min, extracting with ether, washing with saturated brine, anhydrous magnesium sulfate drying and concentrating under reduced pressure, then separating by column chromatography;

The mass ratio of anhydrous tetrahydrofuran, anhydrous chromium trichloride, 1,4,5,8-tetramethoxynaphthalene-2-carbaldehyde, trimethylchlorosilane, allyl bromide, manganese powder is 10:30:30:80:30:800.

Step 2: preparing polyvinylidene fluoride-aromatic ether copolymers:

adding polyvinylidene fluoride and N,N-dimethylformamide to double glass reactor, stirring evenly, then adding Me₆TREN and 2-(1-hydroxy-3-butene) -1,4,5,8-tetramethoxynaphthalene, injecting argon to remove oxygen for 30 min, adding cuprous chloride, removing oxygen for 1 hour, then sealing the reactor, removing the reactor to ice-water bath, reacting for 20 s-3 min under the ultraviolet irradiation in the magnetic stirring, filtering with the volume ratio of 1:1 of ethanol and water after the reaction, then extracting with chloroform several times, finally vacuum-drying to obtain the polyfluoroethylene-aromatic ether copolymer.

The mass ratio of 2-(1-hydroxy-3-butene-1,4,5,8-tetramethoxynaphthalene, polyvinylidene fluoride, N,N-dimethylformamide, cuprous chloride/Me6TREN is 30:12:4001.

Step 3: reducing the polyvinylidene fluoride-aromatic ether copolymer to quinone by demethoxy oxidation:

More specifically, adding the polyvinylidene fluoride-aromatic ether copolymer of acetonitrile solution in the 2 mouth flask, adding cerium ammonium nitrate aqueous solution at room temperature with stirring, reacting for 1 hour, negative pressure recovery of acetonitrile, extracting with chloroform, washing with water, and washing with saturated brine, anhydrous magnesium sulfate drying for 1.5 hour, negative pressure recovery of chloroform, separating the solids by column chromatography to obtain the mixture of 2-(1-hydroxy-3-butene) -5,8-dimethoxy-1,4-naphthoquinone and 6-(1-hydroxy-3-butene) -5,8-dimethoxy-1,4-naphthoquinone, finally vacuum drying.

The eluent of silica column chromatography is the mixture of the petroleum ether and acetone with a volume ratio of 3:1.

Step 4: using the product of step 3 and N,N-dimethylformamide film-forming reagents, then scraping into a membrane.

The mass ratio of N,N-dimethylformamide and the product of step 3 is 15:85.

### Embodiment 3

The method for preparation of polyvinylidene fluoride membrane with functional anthraquinones comprises the following steps:

Step 1: preparing 2-(1-hydroxy-3-butene)-1,4,5,8-tetramethoxyl naphthalene:

1a). preparing 1,4,5,8-tetramethoxynaphthalene:

Adding naphthazarin, tetramethylammonium bromide and tetrahydrofuran to a round bottom flask, stirring to dissolve, then adding sodium dithionite aqueous solution and dimethyl sulfate solution, stirring evenly; then moving the round bottom flask to ice water bath, reacting for 1 h, then slowly dropping NaOH aqueous solution into the flask. After the drop adding, removing the ice bath, continue to react at room temperature for 30 min, and stirring continuously for 18 h until the reaction was complete. Then extracting the reaction solution with ethyl acetate, washing with saturated brine, drying by anhydrous magnesium sulfate, filtering, and recovering of ethyl acetate under reduced pressure. Finally, separating the solids by column chromatography to obtain the 1,4,5,8-tetramethoxynaphthalene;

The mass ratio of naphthazarin, tetrahydrofuran, sodium dithionite, dimethyl sulfate and sodium hydroxide is 2:70:60:100:100;

1b). preparing 1,4,5,8-tetramethoxynaphthalene-2-carboxaldehyde:

Adding N,N-2-methylacetamide to the 2 mouth flask, removing the flask in an ice-water bath, slowly dropping phosphorus oxychloride and 0.063 mol/L 1,4,5,8-tetramethoxynaphthalene in chloroform solution, After the drop adding, removing the ice bath, heating and refluxing reaction for 5 h; then adding ice water to stop the reaction, extracting by chloroform, saturated brine washing, anhydrous magnesium sulfate drying, then filtering, and negative pressure recovery of chloroform, separating by column chromatography;

The volume ratio of N,N-2-methylacetamide, phosphorus oxychloride, 1,4,5,8-tetramethoxynaphthalene in chloroform is 3:2:25.

1c). preparing 2-(1-hydroxy-3-butene)-1,4,5,8-tetramethoxynaphthalene:

Under the protection of argon, adding molecular sieve, anhydrous tetrahydrofuran, anhydrous chromium trichloride and manganese powder in turn in the dry 2 mouth flask, stirring until the color becomes black, then adding allyl bromide, adding 1,4,5,8-tetramethoxynaphthalene-2-carbaldehyde and trimethylchlorosilane, reacting for 3 h, adding sodium bicarbonate to stop the reaction, washing with diatomite and ether, extracting by ether, saturated brine washing, anhydrous magnesium sulfate drying, and negative pressure recovery of the concentrated residue, dissolving in tetrahydrofuran, and hydrolyzing with 10% hydrochloric acid, stirring at room temperature for 10 min, extracting with ether, washing with saturated brine, anhydrous magnesium sulfate drying and concentrating under reduced pressure, then separating by column chromatography;

The mass ratio of anhydrous tetrahydrofuran, anhydrous chromium trichloride, 1,4,5,8-tetramethoxynaphthalene-2-carbaldehyde, trimethylchlorosilane, allyl bromide, manganese powder is 30:10:60:30:80:800.

Step 2: preparing: polyvinylidene fluoride-aromatic ether copolymers:

adding polyvinylidene fluoride and N,N-dimethylformamide to double glass reactor, stirring evenly, then adding Me₆TREN and 2-(1-hydroxyl-3-butene) -1,4,5,8-tetramethoxynaphthalene, injecting argon to remove oxygen for 30 min, adding cuprous chloride, removing oxygen for 1 hour, then sealing the reactor, removing the reactor to ice-water bath reacting for 20 s-3 min under the ultraviolet irradiation in the magnetic stirring, filtering with the volume ratio of 1:1 of ethanol and water after the reaction, then extracting with chloroform several times, finally vacuum-drying to obtain the polyfluoroethylene-aromatic ether copolymer.

The mass ratio of 2-(1-hydroxy-3-butene)-1,4,5,8-tetramethoxynaphthalene, polyvinylidene fluoride, N,N-dimethylformamide, cuprous chloride/Me6TREN is 60:5:550:0.1.

Step 3: reducing the polyvinylidene fluoride-aromatic ether copolymer to quinone by demethoxy oxidation:

More specifically, adding the polyvinylidene fluoride-aromatic ether copolymer of acetonitrile solution in the 2 mouth flask, adding cerium ammonium nitrate aqueous solution at room temperature with stirring, reacting for 1 hour, negative pressure recovery of acetonitrile, extracting with chloroform, washing with water, and washing with saturated brine, anhydrous magnesium sulfate drying for 1.5 hour, negative pressure recovery of chloroform, separating the solids by column chromatography to obtain the mixture of 2-(1-hydroxy-3-butene) -5,8-dimethoxy-1,4-naphthoquinone and 6-(1-hydroxy-3-butene) -5,8-dimethoxy-1,4-naphthoquinone, finally vacuum drying.

The eluent of silica column chromatography is the mixture of the petroleum ether and acetone with a volume ratio of 3:1.

Step 4: using the product of step 3 and N,N-dimethylformamide as film-forming reagents, then scraping into a membrane.

The mass ratio of N,N-dimethylformamide and the product of step 3 is 20:80.

The application data of polyvinylidene fluoride membrane with functional anthraquinones in the degradation of nitrogen-containing wastewater are shown in

TABLE 1

| | The | The | The nitrogen- | The nitrogen- |
|---|---|---|---|---|
| | nitrogen- | nitrogen- | containing | containing |
| | containing | containing | wastewater | wastewater |
| | wastewater | wastewater | treated by the | treated by the |
| | without | treated by | product of | product of |
| Test items | treatment | PVDF | embodiment 1 | embodiment 2 |
| Nitrogen | 200 mg/L | 56 mg/L | 16 mg/L | 20 mg/L |
| content | | | | |
| Removal | — | 72% | 92% | 90% |
| rate | | | | |

What is claimed is:

1. A method for preparation of polyvinylidene fluoride membrane with functional anthraquinones, the method comprising:
step 1: preparing 2-(1-hydroxy-3-butene)-1,4,5,8-tetramethoxyl naphthalene;
step 2: preparing polyvinylidene fluoride-aromatic ether copolymers: polyvinylidene fluoride was used as the initiator, 2-(1-hydroxy-3-butene) -1,4,5,8-tetramethoxynaphthalene was the monomer, N,N-dimethylformamide was solvent, cuprous chloride/Me6TREN was the catalytic, polyvinylidene fluoride-aromatic ether copolymer was synthesized by atomic transfer radical polymerization;
step 3: reducing the polyvinylidene fluoride-aromatic ether copolymer to quinone by demethoxy oxidation;
step 4: using the product of step 3 and N,N-dimethylformamide as film-forming reagents, then scraping into a membrane.

2. The method of claim 1, wherein the method of preparing 2-(1-hydroxy-3-butene) -1,4,5,8-tetramethoxyl naphthalene from step 1 comprises steps of:
step 1a). preparing 1,4,5,8-tetramethoxynaphthalene:
adding naphthazarin, tetramethylammonium bromide and tetrahydrofuran to a round bottom flask, stirring to dissolve, then adding sodium dithionite aqueous solution and dimethyl sulfate solution, stirring evenly; then moving the round bottom flask to ice water bath, reacting for 1 h, then slowly dropping NaOH aqueous solution into the flask. After the drop adding, removing the ice bath, continue to react at room temperature for 30 min, and stirring continuously for 18 h until the reaction was complete. Then extracting the reaction solution with ethyl acetate, washing with saturated brine, drying by anhydrous magnesium sulfate, filtering, and recovering of ethyl acetate under reduced pressure. Finally, separating the solids by column chromatography to obtain the 1,4,5,8-tetramethoxynaphthalene;
step 1b). preparing 1,4,5,8-tetramethoxynaphthalene-2-carboxaldehyde:
adding N,N-2-methylacetamide to the 2 mouth flask, removing the flask in an ice-water bath, slowly dropping phosphorus oxychloride and 0.063 mol/L 1,4,5,8-tetramethoxynaphthalene in chloroform solution, After the drop adding, removing the ice bath, heating and refluxing reaction for 5 h; then adding ice water to stop the reaction, extracting by chloroform, saturated brine washing, anhydrous magnesium sulfate drying, then filtering, and negative pressure recovery of chloroform, separating by column chromatography;
step 1c). preparing 2-(1-hydroxy-3-butene)-1,4,5,8-tetramethoxynaphthalene:
under the protection of argon, adding molecular sieve, anhydrous tetrahydrofuran, anhydrous chromium trichloride and manganese powder in turn in the dry 2 mouth flask, stirring until the color becomes black, then adding allyl bromide, adding 1,4,5,8-tetramethoxynaphthalene-2-carbaldehyde and trimethylchlorosilane, reacting for 3 h, adding sodium bicarbonate to stop the reaction, washing with diatomite and ether, extracting by ether, saturated brine washing, anhydrous magnesium sulfate drying, and negative pressure recovery of the concentrated residue, dissolving in tetrahydrofuran, and hydrolyzing with 10% hydrochloric acid, stirring at room temperature for 10 min, extracting with ether, washing with saturated brine, anhydrous magnesium sulfate drying and concentrating under reduced pressure, then separating by column chromatography.

3. The method of claim 2, wherein the mass ratio of naphthazarin, tetrahydrofuran, sodium dithionite, dimethyl sulfate and sodium hydroxide from step 1a) is 1.2-2:70-80:50-60:100-120:100-150.

4. The method of claim 2, wherein the volume ratio of N,N-2-methylacetamide, phosphorus oxychloride, 1,4,5,8-tetramethoxynaphthalene in chloroform from step 1b) is 2-3:2-5:10-25.

5. The method of claim 2, wherein the mass ratio of anhydrous tetrahydrofuran, anhydrous chromium trichloride, 1,4,5,8-tetramethoxynaphthalene-2-carbaldehyde, trimethylchlorosilane, allyl bromide, manganese powder in step 1c) is 10-30:10-30:30-60:30-80:30-80:600-800.

6. The method of claim 2, wherein the eluants used in the step (1a), step (1b) and (1c) are the petroleum ether and acetone mixed solvent in volume ratio of 4:1.

7. The method of claim 1, wherein the mass ratio of 2-(1-hydroxy-3-butene) -1,4,5,8-tetramethoxynaphthalene, polyvinylidene fluoride, N,N-dimethylformamide, the catalytic from step 2 is 30-60:15-12:400-550:0.1-1.

8. The method of claim 1, wherein the method of reducing the polyvinylidene fluoride-aromatic ether copolymer to quinone by demethoxy oxidation from step 3 comprising:
adding the polyvinylidene fluoride-aromatic ether copolymer of acetonitrile solution in a 2 mouth flask, adding cerium ammonium nitrate aqueous solution at room temperature with stirring, reacting for 1 hour, negative pressure recovery of acetonitrile, extracting with chloroform, washing with water, and washing with saturated brine, anhydrous magnesium sulfate drying for 1,5 hour, negative pressure recovery of chloroform, separating the solids by column chromatography to obtain the mixture of 2-(1-hydroxy-3-butene)-5,8-dimethoxy-1,4-naphthoquinone and 6(1-hydroxy-3-butene)-5,8-dimethoxy-1,4-naphthoquinone, finally vacuum drying.

9. The method of claim 8, wherein the eluent of silica column chromatography is the mixture of the petroleum ether and acetone with a volume ratio of 3:1.

10. The method of claim 1, wherein the mass ratio of the product of step 3 and N, N-dimethylformamide from step 4 is 80-85:15-20.
